(19) United States
(12) Patent Application Publication
(10) Pub. No.: US 2025/0203306 A1
(43) Pub. Date: Jun. 19, 2025

(54) PRESSURE SENSOR FOR SPEAKER DETECTION

(71) Applicant: Apple Inc., Cupertino, CA (US)

(72) Inventors: Gregory B. ARNDT, San Jose, CA (US); David G. HAVSKJOLD, Portola Valley, CA (US)

(21) Appl. No.: 18/919,292

(22) Filed: Oct. 17, 2024

Related U.S. Application Data
(60) Provisional application No. 63/611,684, filed on Dec. 18, 2023.

(51) Int. Cl. H04R 29/00; G01L 19/14; G01L 23/08

(52) U.S. Cl. CPC H04R 29/001; G01L 23/08; G01L 19/14

(57) ABSTRACT

Aspects of the subject technology relate to electronic devices with pressure sensors for speaker detection. The electronic device includes a housing and a speaker disposed in the housing. The electronic device also includes a pressure sensor disposed within the housing and proximate to the speaker. The pressure sensor is configured to monitor an internal volume within a cavity of the housing. The pressure sensor is also configured to generate, based at least in part on detection of a change in the internal volume within the cavity of the housing, a signal indicating that an output device disposed in the housing is in a valid operational state.

### CROSS-REFERENCE TO RELATED APPLICATION(S)

This application claims the benefit of U.S. Provisional Application Ser. No. 63/611,684, entitled “PRESSURE SENSOR FOR SPEAKER DETECTION,” and filed on Dec. 18, 2023, the disclosure of which is expressly incorporated by reference herein in its entirety.

### TECHNICAL FIELD

The present description relates generally to portable electronic devices, and more particularly, but not exclusively, to portable electronic devices with pressure sensors.

### BACKGROUND

Electronic pressure sensors are often used to obtain barometric pressure measurements for elevation and/or weather measurements. However, challenges can arise when attempting to bridge a gap between pressure measurements and the complexities of speaker detection.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a cross-sectional side view of an electronic device in accordance with various aspects of the subject technology.

FIG. 2 illustrates a cross-sectional side view of an electronic device having a pressure sensor for speaker detection in accordance with various aspects of the subject technology.

FIG. 3 illustrates a flow diagram of an example process of speaker detection with a pressure sensor in accordance with various aspects of the subject technology.

FIG. 4 illustrates plot diagrams of example pressure sensor outputs of speaker detection in an electronic device in accordance with various aspects of the subject technology.

FIG. 5 illustrates an example computing device with which aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The cross-sectional views in the accompanying drawings may not necessarily include cross-hatching. Accordingly, neither the presence nor the absence of cross-hatching conveys or indicates any preference or requirement for particular materials, material properties, element proportions, element dimensions, commonalities of similarly illustrated elements, or any other characteristic, attribute, or property for any element illustrated in the accompanying figure. Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

Portable electronic devices such as a mobile phones, portable music players, smart watches, and tablet computers are provided that include a pressure sensor for sensing environmental pressure. The pressure sensor is sometimes used for barometric pressure measurements, which can be used to identify changes in elevation. The changes in elevation are sometimes used to identify a location or exercise performed by a user of the device (e.g., by an activity monitor application running on processing circuitry of the device when the device is worn or carried by the user while the user walks or runs up a flight of stairs or up a hill).

Pressure sensors are disposed within a housing of the portable electronic device and can sense the environmental pressure outside the housing due to airflow from outside the housing into the housing at various openings or ports. Similarly, a speaker may be disposed within the housing of the portable electronic device and can output audible sound through an opening or port in the housing. However, directly exposing an integrated pressure sensor to some environments can lead to permanent damage or parametric shifts due to contaminants (e.g., dust, salt, water, etc.) in the environment.

Embodiments of the subject technology provide for electronic devices with pressure sensors for speaker detection. The electronic device includes a housing and a pressure sensor disposed within the housing. The pressure sensor can be configured to monitor an internal volume within a cavity of the housing. The pressure sensor also can be configured to generate, based at least in part on detection of a change in the internal volume within the cavity of the housing, a signal indicating that an output device disposed in the housing is in a valid operational state.

In accordance with other aspects of the subject disclosure, an apparatus is provided that includes a substrate and a sensing membrane disposed on the substrate. The sensing membrane may be configured to generate a pressure measurement of an internal volume within a cavity of an electronic device. The sensing membrane also may be configured to generate, in a case that the pressure measurement indicates a change in the internal volume, a signal indicating that an output device disposed in the housing is in a valid operational state.

In accordance with other aspects of the subject disclosure, a method of sensing pressure for speaker detection is provided that includes measuring, by the pressure sensor, a pressure based on one or more oscillations associated with a speaker membrane disposed within a cavity in a housing of an electronic device. The method also includes generating, based at least in part on the measured pressure, a signal indicating that the speaker membrane is in a valid operational state.

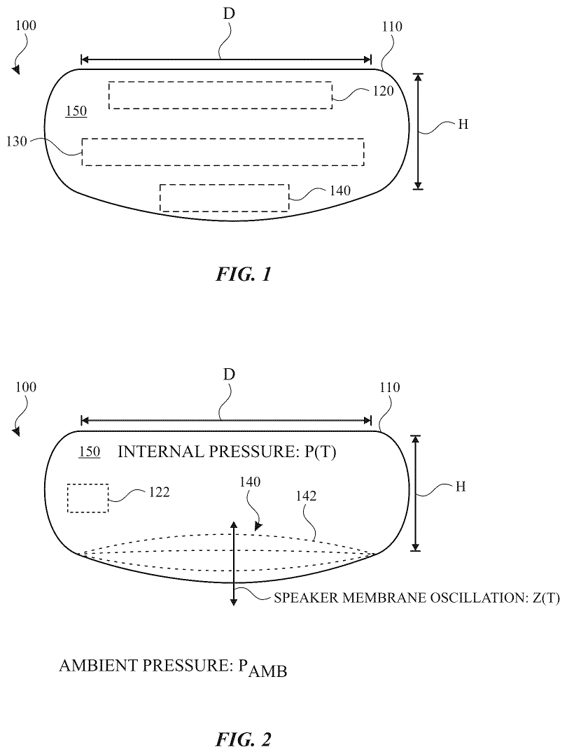

FIG. 1 illustrates a cross-sectional side view of an electronic device in accordance with various aspects of the subject technology. Electronic device 100 can be worn or coupled to a person (e.g., a person's wrist, arm, finger, arm, neck, waist, ankle, or other suitable body part), can be worn or coupled to an animal (e.g., cat, dog, etc.), or can be coupled to an object (e.g., a suitcase, key fob, a doorknob, an electronic device, or any other suitable object). Electronic device 100 can be configured to communicate with one or more additional electronic devices such as a laptop computer, a computer monitor containing an embedded computer, a tablet computer, a desktop computer, a cellular telephone, a media player, or other handheld or portable electronic device, a smaller device such as a wristwatch device, a pendant device, a headphone or earpiece device, a head-mounted device such as glasses, goggles, a helmet, or other equipment worn on a user's head, or other wearable or miniature device, a television, a computer display that does not contain an embedded computer, a gaming device, a remote control, a navigation device, an embedded system such as a system in which equipment is mounted in a kiosk, in an automobile, airplane, or other vehicle, or equipment that implements the functionality of two or more of these devices.

With one illustrative configuration, which can sometimes be described herein as an example, electronic device 100 is a small location device associated with a person, animal, or object. Electronic device 100 can have a circular shape, a round shape, an oval shape, a rectangular shape, and/or other suitable shape. Electronic device 100 can have a maximum lateral dimension D between 25 mm and 50 mm, between 50 mm and 100 mm, between 10 mm and 1400 mm, between 5 mm and 75 mm, less than 50 mm, or greater than 50 mm. In one or more implementations, the electronic device 100 can have a height dimension h that is smaller than the lateral dimension D.

Electronic device 100 can communicate with one or more electronic devices such as cellular telephone, tablet computer, laptop computer, wristwatch device, head-mounted device, a device with a speaker, or other electronic device (e.g., a device with a display, audio components, and/or other output components). The one or more electronic devices that communicate with electronic device 100 can sometimes be referred to as host devices. The host devices can run software that is used to track the location of electronic device 100, send control signals to electronic device 100, receive data from electronic device 100, and/or perform other functions related to the operation of electronic device 100.

In the example of FIG. 1, electronic device 100 includes a housing such as housing 110. Housing 110, which can sometimes be referred to as an enclosure or case, can be formed of plastic, glass, ceramics, fiber composites, metal (e.g., stainless steel, aluminum, etc.), other suitable materials, or a combination of any two or more of these materials. Housing 110 can be formed using a unibody configuration in which some or all of housing 110 is machined or molded as a single structure or can be formed using multiple structures (e.g., an internal frame structure, one or more structures that form exterior housing surfaces, etc.).

Electronic device 100 can include one or more energy storage devices 130. Energy storage devices 130 can include batteries and capacitors. Capacitors for energy storage can be based on supercapacitor structures. Energy storage devices 130 may, for example, include super capacitor(s) such as electrostatic double-layer capacitors. Electrostatic double-layer capacitors (sometimes referred to as electrostatic double-layer supercapacitors) are electrochemical capacitors in which energy is stored in a capacitor formed from relatively large electrodes that are bathed in electrolyte and separated by a small distance, allowing the capacitor to achieve high energy storage capacities.

Energy storage device 130 can be charged via a wired connection or, if desired, electronic device 100 can charge energy storage device 130 using wirelessly received power (e.g., inductive wireless power transfer, using capacitive wireless power transfer, and/or other wireless power transfer configurations). In some arrangements, which can sometimes be described herein as an example, energy storage device 130 is a removable battery that can be replaced.

Electronic device 100 can include electrical components 120 mounted in housing 110. Electrical components 120 can include integrated circuits, discrete components, light-emitting components, sensors, and/or other circuits and may, if desired, be interconnected using signal paths in one or more printed circuits. If desired, one or more portions of the housing walls can be transparent to light and/or sound (e.g., so that light associated with an image on a display or other light-emitting or light-detecting component can exit housing 110, so that sound from a speaker in electronic device 100 can exit housing 110, etc.).

Electrical components 120 can include control circuitry. The control circuitry can include storage and processing circuitry for supporting the operation of electronic device 100. The storage and processing circuitry can include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in the control circuitry can be used to control the operation of electronic device 100. For example, the processing circuitry can use sensors and other input-output circuitry to gather input and to provide output and/or to transmit signals to external equipment. The processing circuitry can be based on one or more microprocessors, microcontrollers, digital signal processors, baseband processors, power management units, audio chips, application specific integrated circuits, etc. The control circuitry can include wired and/or wireless communications circuitry (e.g., antennas and associated radio-frequency transceiver circuitry such as cellular telephone communications circuitry, wireless local area network communications circuitry, etc.). The communications circuitry of the control circuitry can allow electronic device 100 to communicate with other electronic devices. For example, the control circuitry (e.g., communications circuitry in the control circuitry) can be used to allow wired and/or wireless control commands and other communications to be conveyed between devices such as cellular telephones, tablet computers, laptop computers, desktop computers, head-mounted devices, handheld controllers, wristwatch devices, other wearable devices, keyboards, computer mice, remote controls, speakers, accessory displays, accessory cameras, and/or other electronic devices. Wireless communications circuitry may, for example, wirelessly transmit control signals and other information to external equipment in response to receiving user input or other input from sensors or other devices in components 120.

Input-output circuitry in components 120 of electronic device 100 can be used to allow data to be supplied to electronic device 100 and to allow data to be provided from electronic device 100 to external devices. The input-output circuitry can include input devices that gather user input and other input and can include output devices that supply visual output, audible output, or other output.

Output can be provided using light-emitting diodes (e.g., crystalline semiconductor light-emitting diodes for status indicators and/or displays, organic light-emitting diodes in displays and other components), lasers, and other light-emitting devices, audio output devices (e.g., tone generators and/or speakers), haptic output devices (e.g., vibrators, electromagnetic actuators, piezoelectric actuators, and/or other equipment that supplies a user with haptic output), and other output devices.

The input-output circuitry of electronic device 100 (e.g., the input-output circuitry of components 120) can include sensors. Sensors for electronic device 100 can include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into a display, a two-dimensional capacitive touch sensor and/or a two-dimensional force sensor overlapping a display, and/or a touch sensor or force sensor that forms a button, trackpad, or other input device not associated with a display), and other sensors. Touch sensors for a display or for other touch components can be based on an array of capacitive touch sensor electrodes, acoustic touch sensor structures, resistive touch components, force-based touch sensor structures, a light-based touch sensor, or other suitable touch sensor arrangements. If desired, a display can have a force sensor for gathering force input (e.g., a two-dimensional force sensor can be used in gathering force input on a display). If desired, electronic device 100 cannot include a display.

In some implementations, component 140 is a speaker that emits sound through housing 110 (e.g., through perforations in housing 110 or other sound-transparent regions of housing 110). In some scenarios a speaker membrane can be operated to move air through the housing 110 of electronic device 100. A speaker in electronic device 100 may, for example, emit sound to help guide a user to the location of electronic device 100.

In one or more implementations, the operational status of the speaker is sought to be confirmed, as the electronic device 100 has the capability to emit a sound when conspicuously positioned near another user. In the field of audio technology, a conventional approach to detecting a speaker involves using a microphone. While the utilization of a microphone may be the evident means for validating the functionality of the speaker, privacy-related trade-offs may arise from the incorporation of a microphone into such a device.

The subject technology provides for enhancing the physical security of the electronic device 100 implemented as a location device and implementing software and firmware mitigations. The electrical components 120 of the electronic device 100 can include a pressure sensor for detection of component 140 implemented as a speaker. For example, the pressure sensor is capable of monitoring the speaker's response when a command is issued from associated system-on-chip (SoC) circuitry to activate the speaker. In one or more other implementations, the utilization of a pressure sensor for this purpose does not engender privacy concerns similar to those associated with a microphone. The pressure sensor offers the potential to selectively measure the speaker's response in a manner that alleviates concerns about privacy or safety intrusion. This approach aims to ensure that the location device can fulfill its safety and tracking functions without compromising user privacy or security.

In one or more implementations, the pressure sensor can confirm that the speaker has emitted sound, ensuring that the location device is functioning as intended. The pressure sensor's data may not only indicate when the speaker is entirely disabled but also when the speaker is muted or behaving abnormally, triggering automated actions. Pressure sensor can include a pressure sensing element (e.g., a micro-electromechanical system element, a piezo element, a sensing membrane coupled to a capacitive or resistive transducer circuit, etc.) and may include processing circuitry to control operation of the pressure sensor. In one or more implementations, the sensing membrane may be disposed on a substrate.

In one or more implementations, the pressure sensor is employed for the detection of changes in internal volume resulting from the operation of the speaker. The pressure sensor can detect audio oscillations during speaker movement. In one or more implementations, the pressure sensor directly detects the speaker's actual movement at its specific frequency. In one or more other implementations, the pressure sensor can detect the sub-harmonics produced by other nearby movements, all based on data collected by the pressure sensor. The operation of the speaker induces oscillations within the housing 110 of the electronic device 100, thereby giving rise to corresponding internal volume oscillations. These internal oscillations in an airflow-restricted volume will result in air pressure oscillations as modeled by the gas law equation. These oscillations can be ascertained by the pressure sensor through two distinct methods: either directly, by capturing the low-frequency operation of the speaker, or indirectly, by measuring the sub-harmonic of the speaker oscillation via the pressure sensor.

FIG. 2 illustrates a cross-sectional side view of an electronic device having a pressure sensor for speaker detection in accordance with various aspects of the subject technology. In the example of FIG. 2, electronic device 100 includes pressure sensor 122. In one or more implementations, pressure sensor 122 is, or at least part of, the electrical components 120 of the electronic device 100. As shown in FIG. 2, pressure sensor 122 is disposed within housing 110 such that pressure sensor 122 is exposed to a surrounding environment inside a cavity 150 enclosed by housing 110 of electronic device 100. Pressure sensor 122 may include a pressure sensor port that allows exposure to the surrounding environment. This permits air to access the pressure sensor 122 for measurement purposes. In some implementations, the surrounding environment can be an atmosphere, for which case pressure sensor 122 is a barometric pressure sensor the pressure sensor port exposes electronic device 100 to an inflow, which in this case can be a gas (e.g., air). Pressure sensor 122 is protected from potentially harsh environments it needs to operate in and damage due to probing, or the like. In addition, this protection should reduce any error in the pressure reading of pressure sensor 122, for example, due to noise, offset, or latency in pressure measurement.

In one or more implementations, the component 140 is implemented as an audible device, such as a speaker. In the realm of technology, attention is drawn to a certain characteristic, namely, sensor noise. In one or more implementations, the pressure sensor 122 may be configured to detect the transmission of audible signals from the component 140 despite the presence of sensor noise. In one or more implementations, the pressure sensor 122 may be implemented as a capacitive sensor, acknowledged for its capacity to deliver superior signal quality. In one or more other implementations, the pressure sensor 122 may be implemented as a high-power sensor with minimal noise.

In one or more implementations, the pressure sensor 122 is disposed within the cavity 150 of the electronic device 100, and it is configured to obtain a pressure measurement, reflecting the prevailing pressure conditions. This data may serve as the foundational reference point from which subsequent calculations are initiated. In one or more implementations, an offset adjustment may be applied to align the reference point with specific requirements. The obtained pressure measurement can serve two significant purposes. First, the pressure measurement can assess the functionality of the speaker. Second, the pressure measurement can facilitate the detection of interactions with the electronic device 100. This proves valuable when the speaker is inactive, yet there is motion related to the electronic device 100.

In one or more implementations, the speaker in the electronic device 100 may be implemented as a surface actuation speaker. In one or more implementations, the speaker includes a voice coil and a magnet, both interconnected within the housing 110, which induces vibrations in the housing 110, producing sound. When the speaker is activated, it creates a wave of internal pressure fluctuations within the cavity 150. This contrasts with the design of speakers in other electronic devices that are oriented towards the external environment and have minimal impact on the internal pressure of the electronic device. The speaker implementation within the electronic device 100 can be likened to incorporating a pressure sensor inside a drum, where the electronic device 100 acts as a low-frequency drum to produce sound.

As depicted in FIG. 2, the speaker membrane undergoes oscillations, resulting in fluctuations in the volume of the cavity 150. For example, when the speaker is in operation, the motion of the speaker membrane produces oscillations (e.g., 142), resulting in the compression of the air inside the cavity 150. This compression brings about changes in the internal pressure within the cavity 150. This variation occurs due to the difference in volume between the bottom and the top of the speaker, leading to changes in pressure. For example, as the speaker moves, it displaces air within the cavity 150, leading to fluctuations in air pressure over time. Considering that the cavity 150 is hermetically sealed and has low air resistance, it implies that any change in volume affects the air pressure within the cavity 150. Stated another way, altering the volume directly impacts the air pressure inside the cavity 150. This relationship between volume and pressure becomes evident when the membrane of the speaker is oscillating, resulting in the pressure sensor responding to these pressure changes.

In one or more implementations, these variations correspond to waveforms, which may be represented as sine waves. In one or more implementations, the speaker operation causes an oscillation of the housing 110, which may be calculated as follows:

$$z ( t ) = {z}_{o} sin ( 2 π ft ) . \qquad ( 1 )$$

In this equation, z(t) represents the speaker membrane oscillation. When the speaker is active, these pressure changes are induced. If the speaker operates at low frequencies, the pressure sensor 122 can directly measure these pressure variations. Even when the speaker produces sound across multiple frequencies, the pressure sensor 122 can still detect these variations, albeit with some added noise in the sensor signal. The oscillation causes a variation of the internal volume (denoted as V(t)), which may be calculated as follows:

$$V ( t ) \approx \frac{π {D}^{2}}{4} [ h + z ( t ) ] \approx \frac{π {D}^{2}}{4} [ h + {z}_{o} sin ( 2 π ft ) ] . \qquad ( 2 )$$

The internal volume oscillation causes an internal pressure (denoted as P(t)) variation that can be calculated with gas law, which may be calculated as follows:

$$P ( t ) = \frac{n R T}{V ( t )} . \qquad ( 3 )$$

While before speaker operation, the ambient pressure (denoted as P_{amb}) is calculated as follows:

$${P}_{amb} {V}_{o} = nRT . \qquad ( 4 )$$

Therefore, the pressure variation can be calculated as follows:

$$P ( t ) = \frac{{P}_{amb} {V}_{o}}{{V}_{o} + \frac{π {D}^{2}}{4} {z}_{o} sin ( 2 π ft )} \approx {P}_{amb} [ 1 - \frac{π {D}^{2}}{4 {V}_{o}} {z}_{o} sin ( 2 π ft ) ] \approx {P}_{amb} [ 1 - \frac{{z}_{o}}{h} sin ( 2 π ft ) ] . \qquad ( 5 )$$

In one or more implementations, the calculations resulting from Equations 1-5 lead to the determination of an expected pressure measurement value. In one or more implementations, these calculated values are not explicitly predetermined or regarded as precisely known figures. Rather, they can be characterized as estimated values or expected values that may depend on a multitude of factors, predominantly contingent upon the environmental conditions and the specific implementation of the electronic device 100, the pressure sensor 122 and the component 140.

The oscillation pattern obtained from the pressure sensor 122 may be subject to comparison with the expected pressure measurement value. In one or more implementations, the comparison can occur under substantially identical conditions in various locations. In one or more other implementations, the comparison can involve pattern recognition using a trained machine learning model to identify specific oscillation patterns or frequency content of the oscillation pattern.

In one or more implementations, the electronic device 100, using the electrical components 120, may perform a comparison between the raw pressure measurement obtained by the pressure sensor 122 and the expected pressure measurement value (determined via one or more of the equations 1-5). This comparison may entail receiving the output pressure signals from the pressure sensor 122, which feed into a logical system responsible for performing the calculation. In one or more implementations, the electrical components 120 includes the logical system. In one or more implementations, a time lag between the raw pressure measurement and the subsequent calculation is typically in a range of a few seconds such that the user is provided with nearly real-time notifications.

The comparison can provide timely feedback (e.g., indicating whether the speaker is in a valid operational state) to the user. For instance, when the raw pressure measurement reaches a certain threshold or duration, the electronic device 100 can initiate the notification process. In this case, the system aggregates data for a relatively brief period, enabling oscillation pattern recognition. Various analyses can be performed by the electrical components 120 or other processing circuitry coupled to the electrical components 120, such as measuring maximum pressure, determining pressure deviations relative to prior pressure measurements, and tracking movements towards zero crossings.

In one or more implementations, the direct output of raw data from the pressure sensor 122 is subsequently processed within the SoC circuitry. The SoC circuitry may be integrated into the electronic device 100, and the processing occurs on-chip. In one or more implementations, the electrical components 120 is, or includes, the SoC circuitry. This arrangement facilitates a rapid and efficient response to pressure variations, delivering real-time notifications to the user. While the raw data from the pressure sensor 122 may be processed using for more advanced techniques, such as through a trained machine learning model, the fundamental data processing occurs on-chip within the electronic device 100.

In one or more implementations, a secure connection can be established between a host device and the electronic device 100. This secure connection can facilitate a protected means for the user on the host device to review the pressure data processed by the electronic device 100, offering an additional layer of privacy and data security. This approach enhances the overall robustness and trustworthiness of the electronic device 100, addressing both tampering concerns and privacy considerations.

In one or more implementations, the electrical components 120 may perform frequency analysis of the raw pressure measurements. By analyzing the oscillation pattern in the frequency domain, the processing circuitry of the electrical components 120 can detect a harmonic pattern. For example, if the speaker oscillation exhibits a frequency of 100 Hertz, it generates not only the primary 100 Hertz signal but also harmonics at 200, 300, 500, and 700 Hertz, resulting in a spectrum of harmonics. Consequently, when the oscillation's frequency increases to two kilohertz, the harmonic range becomes more extensive. In one or more implementations, the pressure sensor 122 can detect the oscillation pattern by measuring the harmonic pattern in the oscillation pattern.

In one or more implementations, the measuring rate of the pressure sensor 122 is configurable. In one or more implementations, the measuring rate of the pressure sensor 122 may correspond to an operating frequency at a specific frequency, such as 100 Hertz. The operating frequency may be subject to a trade-off between power consumption and noise. In one or more other implementations, the measuring rate of the pressure sensor 122 may correspond to an upper frequency limit of about 240 Hertz. In one or more other implementations, the measuring rate of the pressure sensor 122 may correspond to about one kilohertz. The selection of the appropriate measuring rate for the pressure sensor 122 may be based on specific requirements of the application, considering the trade-off between power efficiency and noise levels.

Considering the outputs for high-frequency speaker operations and the pressure sensor 122 operating at a lower operating frequency, such as 100 Hertz, the raw data may appear as a noise-like output from the pressure sensor 122. In one or more implementations, the onboard circuitry of the electronic device 100, such as the electrical components 120, can process this raw data with the noise-like characteristics. In one or more implementations, the electrical components 120 may perform fast Fourier transform (FFT) analysis, allowing for the identification of discernible patterns within the raw data. While the raw data may appear noisy in the time domain, these patterns manifest themselves more clearly in the frequency domain. In one or more implementations, the electrical components 120 may include, or be communicatively coupled to, a trained machine learning algorithms that is configured to identify and classify these patterns, thus enhancing the overall accuracy of data interpretation and analysis.

In one or more implementations, the SoC circuitry issues a command to the speaker, specifying a particular degree of oscillation. Subsequently, in response to this command, the electrical components 120 can initiate a corresponding command to the pressure sensor 122. This process may continue for a specified duration, resulting in aggregation of the output pressure signals from the pressure sensor 122 over this specified duration. In one or more implementations, the aggregation of the output pressure signals may represent an oscillation pattern associated with the speaker.

During normal operation, when the speaker is inactive, the output of the pressure sensor 122 should remain relatively stable, indicating a steady environment inside the housing 110. However, when the speaker is active, specific patterns may be expected in the pressure sensor data, representing the sound generated by the speaker. Alternatively, the pressure sensor 122 may detect significant variations indicating the presence of sound, providing valuable insights into the speaker's activity.

In one or more implementations, the pressure sensor 122 may be configured for in-field calibration of the speaker. The electronic device 100 may employ consistent sound assets sent to the speaker, regardless of the environmental situation. However, the performance of the speaker can exhibit variations, particularly in different environmental conditions with varying pressure levels. Over an extended period, the ambient pressure within the electronic device 100 and that of the external environment tend to acclimate. In this regard, in environments with significantly high or low pressures, the sound produced by the speaker undergoes subtle changes. In one or more implementations, the pressure sensor 122 can determine these pressure variations such that the sound assets sent to the speaker can be tailored for pre-calibration to match the ambient pressure levels, resulting in a more consistent performance of the speaker, regardless of the geographical location.

In one or more implementations, the pressure sensor 122 may serve as an input device to detect if a user is interacting with the electronic device 100. Given that the electronic device 100 may be implemented without physical buttons or a traditional user interface in one or more implementations, the pressure sensor 122 can detect actions such as squeezing or tapping on the electronic device 100, which can trigger various downstream actions such as interacting with another electronic device (e.g., a mobile phone). In essence, this converts the electronic device 100 into a functional button, enabling the electronic device 100 to sense and gather data on user interactions.

The inclusion of a pressure sensor can provide a multitude of advantages, with the primary focus being on detecting speaker performance. However, there are additional aspects to consider that underscore the significance of such a pressure sensor. One of these aspects pertains to the pressure differential between the interior and exterior of the electronic device 100. This pressure discrepancy arises due to various scenarios, such as temporary openings in the electronic device 100 or changes in altitude, which can result in differing air pressures. For example, when the electronic device 100 is rapidly moved to higher elevations, the external pressure decreases due to the lower atmospheric pressure at higher altitudes. The adjustment of internal pressure transpires gradually, as the electronic device 100 regulates to the changing external pressure. However, this process occurs at a relatively slow pace. Consequently, there are instances where the external pressure remains lower than the internal pressure, while the internal pressure within the cavity 150 strives to equalize with the external environment. In scenarios where the internal pressure surpasses the external pressure significantly, the speaker within the electronic device 100 can experience deformation. This deformation results from the higher internal pressure pushing the speaker membrane downward, thereby altering its equilibrium. Such variations in the speaker's equilibrium can have perceptible effects on sound quality. In this regard, embodiments of the subject technology provide for the integration of a pressure sensor not only to address detection of speaker performance but also enable the electronic device 100 to adapt more effectively to changes in external pressure, ensuring a more consistent speaker performance and sound quality.

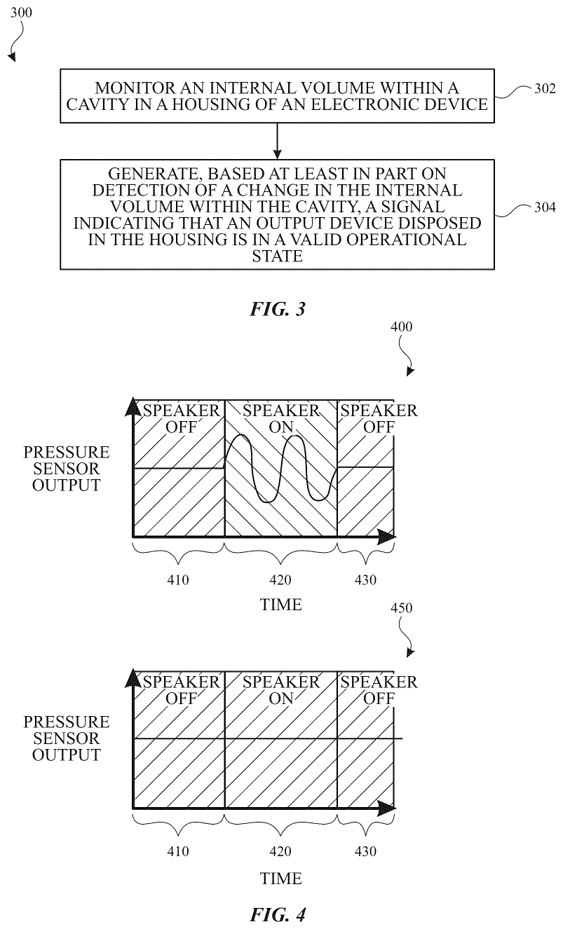

FIG. 3 illustrates a flow diagram of an example process of speaker detection with a pressure sensor in accordance with various aspects of the subject technology. For explanatory purposes, the process 300 is primarily described herein with reference to the electronic device 100 of FIG. 1. However, the process 300 is not limited to the electronic device 100 of FIG. 1, and one or more blocks (or operations) of the process 300 may be performed by one or more other components of other suitable device, such as the pressure sensor 122 of FIG. 2. Further for explanatory purposes, some of the blocks of the process 300 are described herein as occurring in serial, or linearly. However, multiple blocks of the process 300 may occur in parallel. In addition, the blocks of the process 300 need not be performed in the order shown and/or one or more blocks of the process 300 need not be performed and/or can be replaced by other operations.

As illustrated in FIG. 3, at block 302, the pressure sensor 122 monitors an internal volume within the cavity 150 in the housing 110 of the electronic device 100. In one or more implementations, the pressure sensor 122 detects a change in the internal volume within the cavity 150 in the housing 110 of the electronic device 100. The pressure sensor 122 can detect audio oscillations during speaker movement. In one or more implementations, the pressure sensor 122 directly detects the speaker's actual movement at a specific frequency. In one or more other implementations, the pressure sensor 122 can detect the sub-harmonics produced by other nearby movements, all based on data collected by the pressure sensor 122. The operation of the speaker induces oscillations within the housing 110 of the electronic device 100, thereby giving rise to corresponding internal volume oscillations. These oscillations can be ascertained by the pressure sensor 122 through two distinct methods: either directly, by capturing the low-frequency operation of the speaker, or indirectly, by measuring the sub-harmonic of the speaker oscillation via the pressure sensor 122, as described with reference to FIG. 2.

At block 304, the pressure sensor 122 generates, based at least in part on detection of a change in the internal volume within the cavity 150, a signal indicating that an output device, such as a speaker, disposed in the housing 110, is in a valid operational state. In one or more implementations, the electronic device 100 may perform a comparison between raw pressure measurement obtained by the pressure sensor 122 and an expected pressure measurement value (determined via one or more of the equations 1-5 as described with reference to FIG. 2). The comparison can provide timely feedback (e.g., a signal indicating whether the speaker is in a valid operational state) to the user.

FIG. 4 illustrates plot diagrams of example pressure sensor outputs of speaker detection in an electronic device in accordance with various aspects of the subject technology. For example, FIG. 4 illustrates plot diagram 400 having a waveform that is a two-dimensional representation of the pressure sensor 122 output over time. In one or more implementations, the waveform represents a distinctive output from the pressure sensor 122, signaling what it has detected. Stated another way, the waveform serves as the anticipated signal to confirm the speaker's operability within a specific timeframe.

The plot diagram 400 is subdivided into three states over time, namely speaker states 410, 420 and 430. In one or more implementations, the waveform depicts an instance of low-frequency detection by the pressure sensor 122, indicating a successful capture of pressure fluctuations within a specific frequency range, notably within 100 Hertz. In the speaker states 410 and 430, the waveform depicts a steady-state signal at a corresponding pressure sensor output value that indicates the speaker is in a non-operational state. In the speaker states 410 and 430, speaker operation is expected to be off (depicted as “Speaker OFF”) and the waveform during these states appears to correspond to the speaker off state. In the speaker state 420, the waveform depicts a sine wave representation of an active speaker. In the speaker state 420, speaker operation is expected to be on (depicted as “Speaker ON”) and the waveform during this state appears to correspond to the speaker on state, and therefore, the waveform indicates that the speaker is in a valid operational state.

FIG. 4 also illustrates plot diagram 450 having a waveform that depicts a steady-state signal at a corresponding pressure sensor output value that indicates the speaker is in a non-operational state during the speaker states 410-430. In the speaker states 410 and 430, speaker operation is expected to be off (depicted as “Speaker OFF”) and the waveform during these states appears to correspond to the speaker off state. In the speaker state 420, speaker operation is expected to be on (depicted as “Speaker ON”); however, the waveform during this state appears to correspond to a speaker off state, and therefore, the waveform indicates that the speaker is not in a valid operational state.

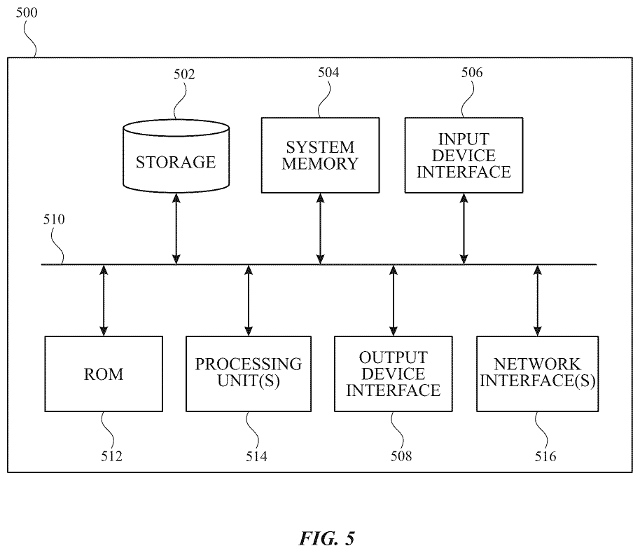

FIG. 5 illustrates an example computing device with which aspects of the subject technology may be implemented in accordance with one or more implementations. The computing device 500 can be, and/or can be a part of, any computing device or server for generating the features and processes described above, including but not limited to a laptop computer, a smartphone, a tablet device, a wearable device such as a goggles or glasses, and the like. The computing device 500 may include various types of computer readable media and interfaces for various other types of computer readable media. The computing device 500 includes a permanent storage device 502, a system memory 504 (and/or buffer), an input device interface 506, an output device interface 508, a bus 510, a ROM 512, one or more processing unit(s) 514, one or more network interface(s) 516, and/or subsets and variations thereof.

The bus 510 collectively represents all system, peripheral, and chipset buses that communicatively connect the numerous internal devices of the computing device 500. In one or more implementations, the bus 510 communicatively connects the one or more processing unit(s) 514 with the ROM 512, the system memory 504, and the permanent storage device 502. From these various memory units, the one or more processing unit(s) 514 retrieves instructions to execute and data to process in order to execute the processes of the subject disclosure. The one or more processing unit(s) 514 can be a single processor or a multi-core processor in different implementations.

The ROM 512 stores static data and instructions that are needed by the one or more processing unit(s) 514 and other modules of the computing device 500. The permanent storage device 502, on the other hand, may be a read-and-write memory device. The permanent storage device 502 may be a non-volatile memory unit that stores instructions and data even when the computing device 500 is off. In one or more implementations, a mass-storage device (such as a magnetic or optical disk and its corresponding disk drive) may be used as the permanent storage device 502.

In one or more implementations, a removable storage device (such as a flash drive and its corresponding solid-state drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing unit(s) 514 may need at runtime. In one or more implementations, the processes of the subject disclosure are stored in the system memory 504, the permanent storage device 502, and/or the ROM 512. From these various memory units, the one or more processing unit(s) 514 retrieves instructions to execute and data to process in order to execute the processes of one or more implementations.

The bus 510 also connects to the input and output device interfaces 506 and 508. The input device interface 506 enables a user to communicate information and select commands to the computing device 500. Input devices that may be used with the input device interface 506 may include, for example, alphanumeric keyboards and pointing devices (also called “cursor control devices”). The output device interface 508 may enable, for example, the display of images generated by computing device 500. Output devices that may be used with the output device interface 508 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 510 also couples the computing device 500 to one or more networks and/or to one or more network nodes through the one or more network interface(s) 516. In this manner, the computing device 500 can be a part of a network of computers (such as a LAN, a wide area network (“WAN”), or an Intranet, or a network of networks, such as the Internet. Any or all components of the computing device 500 can be used in conjunction with the subject disclosure.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media. The computer- readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device as described herein for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read- only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the clement is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An electronic device, comprising:
a housing; and
a pressure sensor disposed within the housing and configured to:
monitor an internal volume within a cavity of the housing; and
generate, based at least in part on detection of a change in the internal volume within the cavity of the housing, a signal indicating that an output device disposed in the housing is in a valid operational state.

2. The electronic device of claim 1, wherein the pressure sensor is further configured generate a pressure measurement indicating the detected change in internal volume within the cavity.

3. The electronic device of claim 1, further comprising processing circuitry configured to determine an estimated pressure measurement value based on one or more environmental conditions associated with the pressure sensor and the output device.

4. The electronic device of claim 3, wherein the processing circuitry is further configured to perform a comparison between one or more pressure measurements obtained by the pressure sensor and the estimated pressure measurement value, wherein the signal is generated from the comparison.

5. The electronic device of claim 1, wherein the pressure sensor is further configured to detect one or more oscillations associated with a membrane of the output device, wherein the change in internal volume corresponds to the one or more oscillations associated with the membrane of the output device.

6. The electronic device of claim 5, wherein the one or more oscillations are detected based at least in part on a frequency operation of the output device being smaller than a measuring rate of the pressure sensor.

7. The electronic device of claim 5, wherein the one or more oscillations are detected based at least in part on measuring a harmonic pattern in the one or more oscillations.

8. An apparatus, comprising:
a substrate; and
a sensing membrane disposed on the substrate and configured to:
generate a pressure measurement of an internal volume within a cavity of an electronic device; and
generate, in a case that the pressure measurement indicates a change in the internal volume, a signal indicating that an output device disposed in the apparatus is in a valid operational state.

9. The apparatus of claim 8, further comprising processing circuitry configured to determine an estimated pressure measurement value based on one or more environmental conditions associated with the sensing membrane and the output device.

10. The apparatus of claim 9, wherein the processing circuitry is further configured to perform a comparison between one or more pressure measurements obtained by the sensing membrane and the estimated pressure measurement value, wherein the signal is generated from the comparison.

11. The apparatus of claim 8, wherein the sensing membrane is further configured to detect one or more oscillations associated with a membrane of the output device, wherein the pressure measurement indicates changes in pressure that correspond to the one or more oscillations.

12. The apparatus of claim 11, wherein the one or more oscillations are detected based at least in part on a frequency operation of the output device being smaller than a measuring rate of the sensing membrane.

13. The apparatus of claim 11, wherein the one or more oscillations are detected based at least in part on measuring a harmonic pattern in the one or more oscillations.

14. A method, comprising:
measuring, by a pressure sensor, a pressure based on one or more oscillations associated with a speaker membrane disposed within a cavity in a housing of an electronic device; and
generating, based at least in part on the measured pressure, a signal indicating that the speaker membrane is in a valid operational state.

15. The method of claim 14, wherein the measured pressure indicates a change in internal volume within the cavity of the electronic device.

16. The method of claim 14, wherein the measured pressure indicates changes in pressure that correspond to the one or more oscillations.

17. The method of claim 14, further comprising determining an estimated pressure measurement value based on one or more environmental conditions associated with the pressure sensor and the speaker membrane.

18. The method of claim 17, further comprising performing a comparison between the measured pressure and the estimated pressure measurement value, wherein the signal is generated from the comparison.

19. The method of claim 14, further comprising detecting the one or more oscillations based at least in part on a frequency operation of the speaker membrane being smaller than a measuring rate of the pressure sensor.

20. The method of claim 14, further comprising detecting the one or more oscillations based at least in part on measuring a harmonic pattern in the one or more oscillations.
